(19) United States
(12) Patent Application Publication
(10) Pub. No.: US 2014/0201427 A1
(43) Pub. Date: Jul. 17, 2014

(54) STORAGE CONTROL APPARATUS, DATA STORAGE APPARATUS AND METHOD FOR STORAGE CONTROL

(71) Applicant: KABUSHIKI KAISHA TOSHIBA, Tokyo (JP)

(72) Inventors: Kazuya Takada, Kodaira-shi (JP); Kenji Yoshida, Kamakura-shi (JP); Hideo Shimokawa, Ome-shi (JP); Susumu Yamazaki, Yokohama-shi (JP)

(21) Appl. No.: 13/941,239

(22) Filed: Jul. 12, 2013

(30) Foreign Application Priority Data
Jan. 17, 2013 (JP) 2013-006134

(51) Int. Cl. G06F 3/06

(52) U.S. Cl. CPC G06F 3/0685; G06F 3/0646; G06F 3/061
USPC 711/103

(57) ABSTRACT

According to one embodiment, a storage control apparatus includes a first buffer controller and a second buffer controller. The first buffer controller is configured to store data of a first unit in each of data buffer regions, and the data of the first unit is transmitted from a host and written in a nonvolatile memory, or read from the nonvolatile memory and transmitted to the host. The second buffer controller is configured to independently transmit data of a second unit from the data buffer region corresponding to a bank prepared for transmission when data is written in the nonvolatile memory, and to independently transmit data of the second unit from a bank to be read to the data buffer region corresponding to the bank to be read when data is transmitted to the host.

### CROSS-REFERENCE TO RELATED APPLICATIONS

This application is based upon and claims the benefit of priority from Japanese Patent Application No. 2013-006134, filed Jan. 17, 2013, the entire contents of which are incorporated herein by reference.

### FIELD

Embodiments described herein relate generally to a storage control apparatus, a data storage apparatus, and a method for storage control.

### BACKGROUND

Nowadays, nonvolatile memories such as NAND flash memories (hereinafter simply referred to as “flash memories”) are used together with disks, as storage media, in data storage apparatuses represented by hard disk drives (HDDs).

Data storage apparatuses sequentially receive data in sector unit from a host, store the data in a buffer memory such as a DRAM, and thereafter perform buffer control to transmit the data to the flash memory. Generally, data storage apparatuses sequentially write data in the buffer memory, and sequentially read data from the buffer memory.

In buffer control in which data is sequentially written and read, data is only sequentially transmitted and written in the flash memory, although the flash memory includes a plurality of independent banks. Thus, when data transmission from the buffer memory to some of the banks is delayed, data transmission is delayed also for banks which have been prepared for transmission. It is desirable to perform efficient buffer control, in which data is transmitted in order from the buffer memory to banks prepared for data transmission, for a flash memory including a plurality of independent banks.

### BRIEF DESCRIPTION OF THE DRAWINGS

FIG. 1 is a block diagram for explaining a structure of a data storage apparatus according to an embodiment;

FIG. 2 is a block diagram for explaining a structure of a main controller according to the embodiment;

FIG. 3 is a diagram for explaining a bank structure of a flash memory according to the embodiment;

FIG. 4 is a diagram for explaining a structure of a buffer memory according to the embodiment;

FIG. 5 is a diagram for explaining buffer control according to the embodiment;

FIG. 6 is a diagram for explaining data transmission control according to the embodiment; and

FIG. 7 is a flowchart for explaining buffer control processing according to the embodiment.

### DETAILED DESCRIPTION

In general, according to one embodiment, a storage control apparatus for using in a data storage apparatus includes a nonvolatile memory including storage regions for a plurality of banks, and a buffer memory including a plurality of data buffer regions assigned to the banks. The storage control apparatus includes a first buffer controller and a second buffer controller. The first buffer controller is configured to store data of a first unit in each of the data buffer regions, and the data of the first unit is transmitted from a host and written in the nonvolatile memory, or read from the nonvolatile memory and transmitted to the host. The second buffer controller is configured to independently transmit data of a second unit from the data buffer region corresponding to a bank prepared for transmission when data is written in the nonvolatile memory, and to independently transmit data of the second unit from a bank to be read to the data buffer region corresponding to the bank to be read when data is transmitted to the host.

Various embodiments will be described hereinafter with reference to the accompanying drawings.

[Structure of Disk Drive]

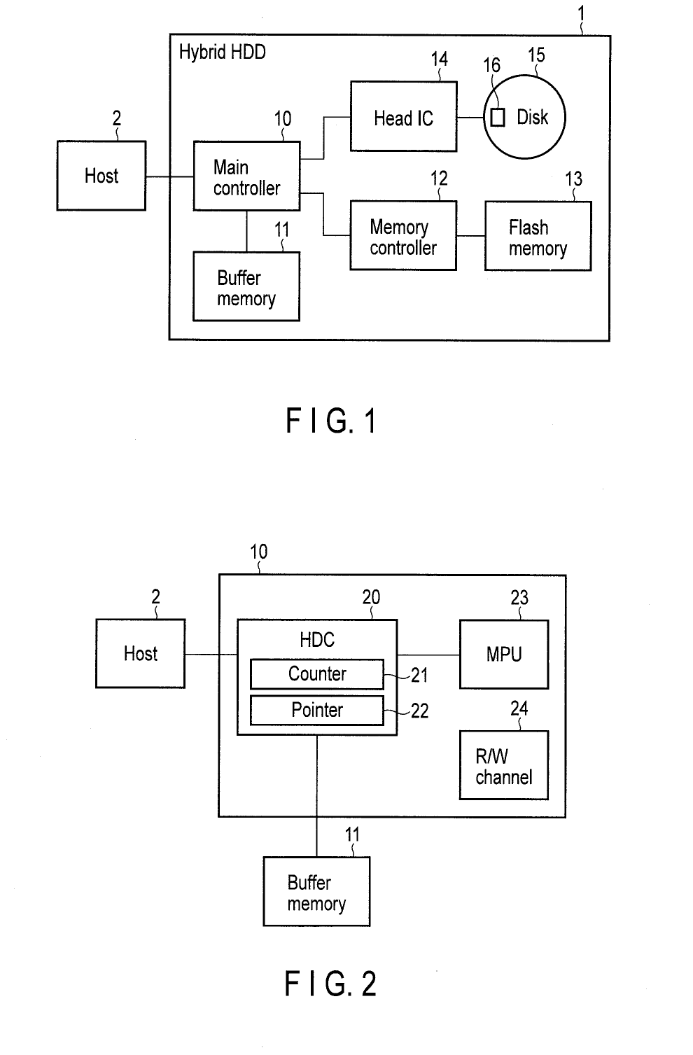

FIG. 1 is a block diagram illustrating a main part of a hybrid hard disk drive (hereinafter simply referred to as a “disk drive”), as a data storage apparatus according to the present embodiment.

As illustrated in FIG. 1, the disk drive 1 comprises a main controller 10, a buffer memory 11, and a memory controller 12, when it is roughly divided. The main controller 10 is a controller which controls the whole operation of the disk drive 1, as described later. The buffer memory 11 is formed of, for example, a dynamic random access memory (DRAM). The buffer memory 11 temporarily stores read data or write data, to control data transmission between the host 2 and the storage medium.

The disk drive 1 includes a flash memory 13 and a disk 15, as the storage medium. The main controller 10 writes and reads data in and from the flash memory 13, through the memory controller 12. The main controller 10 also controls a head amplifier integrated circuit (hereinafter referred to as a “head IC”) 14 and a head 16, and writes and reads data in and from the disk 15.

The head IC 14 includes a read amplifier and a write driver. The read amplifier amplifies a read signal which is read by the head 16, and transmits the read signal to the main controller 10. The write driver transmits a write current, which corresponds to write data outputted from the main controller 10, to the head 16. The head 16 includes a write head and a read head. The write head writes data on the disk 15. The read head reads data from the disk 15.

As illustrated in FIG. 2, the main controller 10 includes a hard disk controller (HDC) 20, a microprocessor unit (MPU) 23, and a R/W channel 24. The R/W channel 24 includes a read channel for executing signal processing for read data, and a write channel for executing signal processing for write data. The R/W channel 24 transmits read/write data between the main controller 10 and the head IC 14.

The HDC 20 controls data transmission between the host 2 and the flash memory 13 or the disk 15. The HDC 20 includes a counter 21 and a pointer 22. As described later, the HDC 20 controls the buffer memory 11, temporarily store read data and write data in the buffer memory 11, and thereby executes data transmission control.

The MPU 23 controls recording and playback of data, in cooperation with the HDC 20. Specifically, the MPU 23 controls the R/W channel 24, and thereby controls writing and reading for the disk 15. The MPU 23 also controls the memory controller 12, and thereby controls writing and reading for the flash memory 13.

[Buffer Control Operation]

Next, operation for buffer control (data transmission control) in the disk drive 1 according to the present embodiment will be explained hereinafter. The present embodiment relates to buffer control (data transmission control) in writing and reading for the flash memory 13. Thus, explanation of writing and reading for the disk 15 is omitted.

Specifically, the present embodiment relates to write data transmission control for transmitting write data from the host 2 to the flash memory 13 through the buffer memory 11. The present embodiment is also applicable to read data transmission control for transmitting read data from the flash memory 13 to the host 2 through the buffer memory 11.

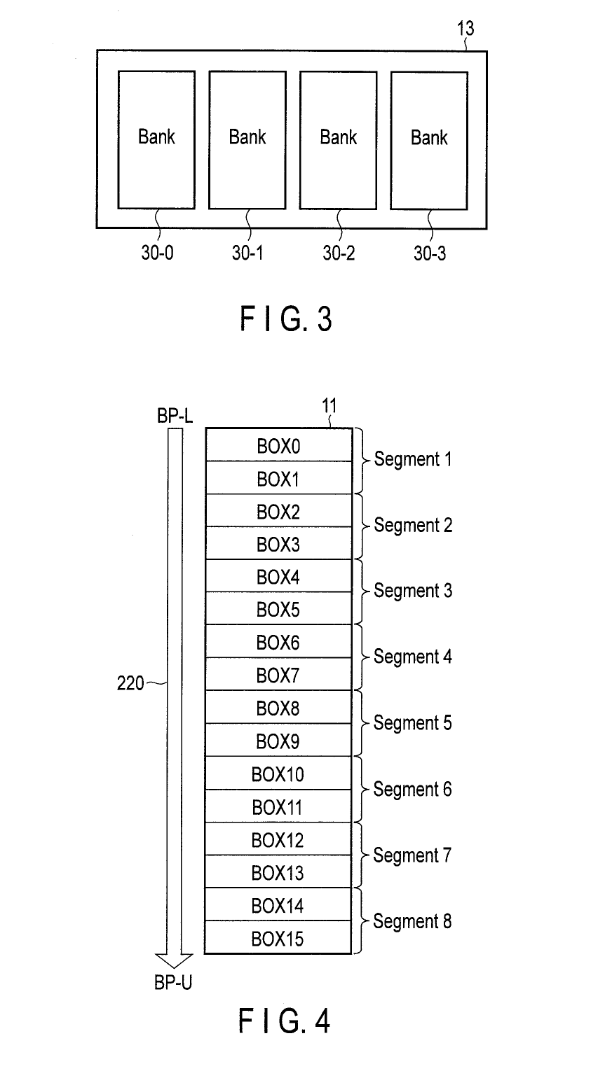

As illustrated in FIG. 3, the flash memory 13 is formed of a plurality of independent banks. For example, the flash memory 13 includes four banks 30-0 to 30-3. Each of banks 30-0 to 30-3 is an assembly of a plurality of memory chips. The memory controller 12 can independently write and read data in and from each bank.

On the other hand, as illustrated in FIG. 4, the buffer memory 11 includes segments (storage region units) which are assigned to the banks, and is managed by the HDC 20. The HDC 20 manages a buffer region 220 ranging from a lower pointer (BP-L) to an upper pointer (BP-U) by the pointer 22. Specifically, the HDC 20 uses the pointer 22 as the write pointer when data is written, and uses the pointer 22 as the read pointer when data is read.

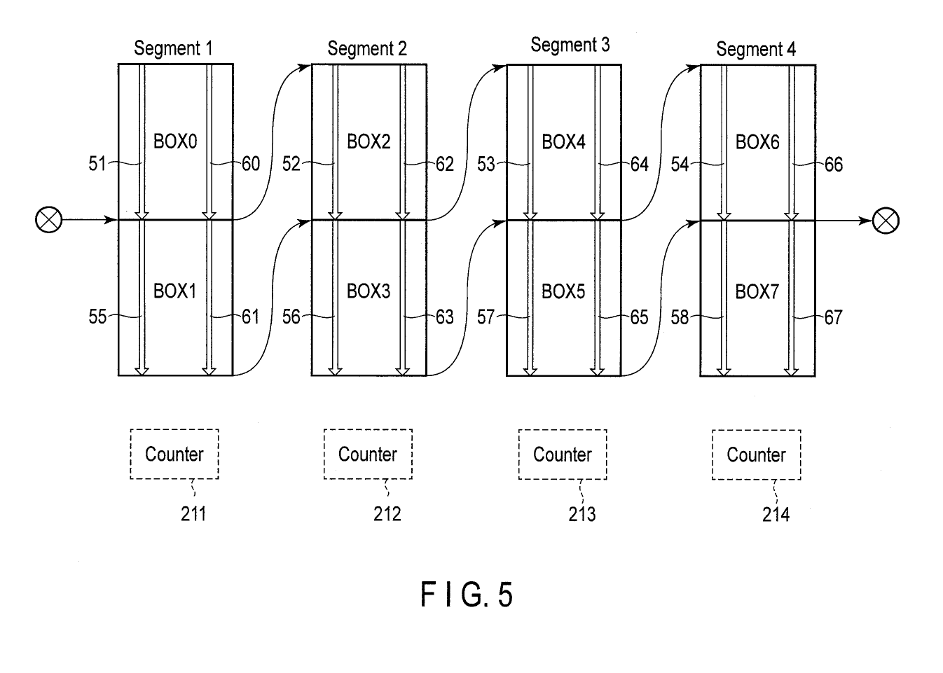

The HDC 20 includes a counter 21, which manages the segments independently of each other and counts the number of sectors of the data stored in sectors as described later. In the present embodiment, as illustrated in FIG. 5, the HDC 20 includes counters 211 to 214, which correspond to segments 1 to 4, respectively, as the counter 21. Specifically, the HDC 20 controls counters 211 to 214, to independently manage segments 1 to 4 which correspond to banks 30-0 to 30-3 (count-up or count-down).

In the present embodiment, 256 sectors of data are sequentially transmitted in sectors from the host 2. One sector is 512 B (where B stands for a byte). The data from the host 2 is written in banks 30-0 to 30-3, for example, in boxes, each including 16 KB. In addition, as illustrated in FIG. 4, each of segments 1 to 4 stores two boxes of data (each box includes 16 KB data).

Buffer control (data transmission control) performed when data which has been sequentially transmitted from the host 2 is written in the flash memory 13 will be explained hereinafter, with reference to FIG. 5 and FIG. 7.

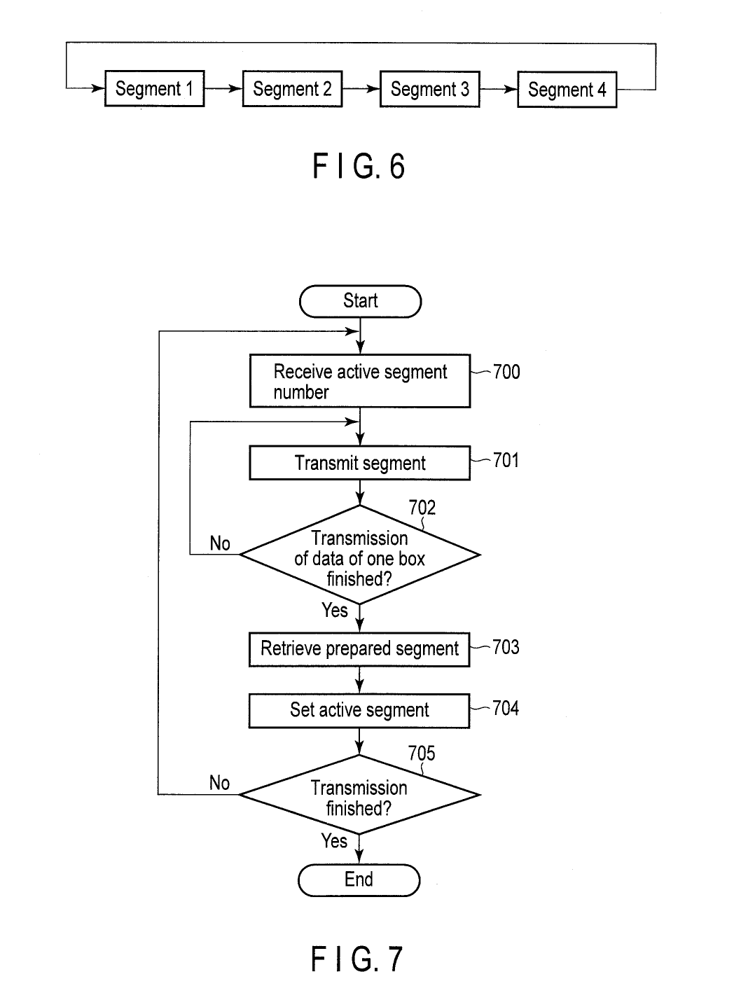

As illustrated in FIG. 5, when the HDC 20 receives the data which has been sequentially transmitted from the host 2, the HDC 20 stores the data in segments 1 to 4 of the buffer memory 11. In the present embodiment, as illustrated in FIG. 6, the HDC 20 executes buffer control in accordance with segment chain information. In the segment chain, the segment is changed to the next segment whenever one box (for example, 16 KB) of data is transmitted.

Specifically, as illustrated in FIG. 5, the HDC 20 controls the pointer 22 as write pointers 51 to 58, and stores data of boxes in segments 1 to 4 of the buffer memory 11. Specifically, the HDC 20 executes buffer control in the order of box 0 of segment 1, box 2 of segment 2, box 4 of segment 3, and box 6 of segment 4. Then, the HDC 20 executes buffer control in the order of box 1 of segment 1, box 3 of segment 2, box 5 of segment 3, and box 7 of segment 4.

In this processing, the HDC 20 controls counters 211 to 214 for the respective segments 1 to 4, to increase the counts by the number of sectors stored in the buffer memory 11 from the host 2. Specifically, at the point in time when data transmission of box 0, box 2, box 4, box 6, and box 1 has been finished, counter 211 increases the count by the number of sectors for two boxes in segment 1. Each of counters 212 and 214 increase the counts by the number of sectors for one box in segments 2 to 4, respectively.

Next, in accordance with the flowchart of FIG. 7, the HDC 20 controls data transmission to write the data stored in the buffer memory 11 in banks 30-0 to 30-3 of the flash memory 13. First, the HDC 20 receives the number of segment (active segment number) which corresponds to one of banks 30-0 to 30-3 used for storing the data, from the MPU 23 (Block 700). Specifically, the HDC 20 reads the data of the designated segment (segment numbers 1 to 4 in this example) from the buffer memory 11, and transmits the data to the flash memory 13.

As illustrated in FIG. 5, the HDC 20 controls the pointer 22 as read pointers 60 to 67, and reads and transmits the data in boxes from segments 1 to 4 of the buffer memory 11. Specifically, the HDC 20 transmits data in a box (16 KB) for each segment (Block 701). In this processing, the HDC 20 transmits data of the former box for each segment, and then transmits data of the latter box.

The HDC 20 transmits the data in the box from the buffer memory 11 to the memory controller 12. The memory controller 12 writes the data in the flash memory 13. Thereby, programming (a write operation) of, for example, approximately 500 μs is finished (YES in Block 702). As a specific example, as illustrated in FIG. 5, the data of box 0 serving as the former part of segment 1 is transmitted to the flash memory 13, and the programming is finished at the point in time when writing the data of box 0 is finished. This processing is repeated until all the data of the box (box 0 in this example) is transmitted from the buffer memory 11 to the memory controller 12 and writing is finished (NO in Block 702).

When the programming of the data of a box is finished, the HDC 20 controls one of counters 211 to 214, to reduce the count by the number of sectors of the data of the box transmitted to the flash memory 13. Specifically, the HDC 20 reduces the count of counter 211 for segment 1.

At the point in time when the programming for data of a box is finished, the HDC 20 can change the active segment as desired. Specifically, the HDC 20 retrieves the segment (active segment) that corresponds to a bank of the flash memory 13, which is prepared for writing (Block 703). The HDC 20 sets the active segment, and starts data transmission from the buffer memory 11 to the flash memory 13 (actually to the memory controller 12), in the same manner as the above (Block 704).

In this processing, the HDC 20 does not always transmit data of box 1 to box 7 in this order, after the programming is finished by transmitting the data of box 0 serving as the former part of segment 1. Specifically, the HDC 20 may transmit data of box 0, box 2, box 4, and box 6 serving as the former parts of segments 1 to 4 in this order, and then transmit data of box 3, box 7, box 5, and box 1 in this order, in accordance with the finishing order of the programming. In each of segments 1 to 4, transmission of the data of the latter box is not started before transmission of the data of the former box in the same segment is finished.

The HDC 20 finishes data transmission, when the data of all the boxes is transmitted from segments 1 to 4 and the programming is finished (YES in Block 705). The HDC 20 controls counters 211 to 214 for segments 1 to 4, and reduces the count of each counter by the number of sectors of the data of the box transmitted to the flash memory 13. This processing is repeated until the data of all the boxes is transmitted from segments 1 to 4 and the programming is finished (NO in Block 705).

As described above, according to the present embodiment, when data of sectors are sequentially transmitted from the host, the data is stored in the buffer memory. In this case, the counters for the respective segments of the buffer memory are controlled, to increase the counts by the number of sectors stored in the buffer memory.

In addition, when data is transmitted from the buffer memory to the flash memory, it is possible to independently take out data from the buffer memory for each segment (active segment) corresponding to the bank of the flash memory. Since the present embodiment enables control of the counters of the respective segment independently of each other, and thus it is possible to manage the number of effective data items which can be transmitted to each segment (each bank). Thus, data is independently transmitted from the buffer memory for each bank of the flash memory. Thereby, even when there is difference in write processing time between the banks of the flash memory, transmission of data can be started in order from the bank which has been prepared for writing.

Although the present embodiment explains write data transmission control, in which write data that is sequentially transmitted from the host (data transmission source) 2 is transmitted to the flash memory (data transmission destination) 13 through the buffer memory 11, the present embodiment is also applicable to read data transmission control.

In read data transmission control, however, data is read from the flash memory 13 (serving as data transmission source) in anon-sequential manner, and stored in the buffer memory 11. The HDC 20 stores data, which has been read from the bank to be read in the flash memory 13 (serving as data transmission source), in a box in a corresponding segment of the buffer memory 11. Next, as described above, the HDC 20 controls the counter for each segment, and executes buffer control of reading sectors of data to be read from the box of the segment which corresponds to the bank to be read, and transmitting the data to the host 2 (serving as the data transmission destination).

In short, according to the present embodiment, first, when data is written in each bank of the flash memory, processing for each bank can be managed independently of the other banks. Thus, the processing waiting time is reduced, and the processing efficiency is improved. Secondly, even when the write processing for some of the banks is delayed, the write processing can be switched to that for a bank which has been prepared for writing. Thus, the write processing is not retarded, and the write processing for the whole flash memory can be continuously carried out. In particular, the present embodiment is effective for the case where data is simultaneously written in the banks and the write processing time greatly differs between the banks.

In addition, even when the reading processing from some of the banks is delayed, the reading processing can be switched to transmission from the segment which corresponds to the bank that has been prepared for transmission to the host. Thus, the reading processing for the whole flash memory can be continued, without delay in the reading processing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage control apparatus for a data storage apparatus which comprises a nonvolatile memory including storage regions for a plurality of banks, and a buffer memory including a plurality of data buffer regions assigned to the banks,
the storage control apparatus comprising:
a first buffer controller configured to store data of a first unit in each of the data buffer regions, the data of the first unit being transmitted from a host and written in the nonvolatile memory, or being read from the nonvolatile memory and transmitted to the host; and
a second buffer controller configured to independently transmit data of a second unit from the data buffer region corresponding to a bank prepared for transmission when data is written in the nonvolatile memory, and to independently transmit data of the second unit from a bank to be read to the data buffer region corresponding to the bank to be read when data is transmitted to the host.

2. The storage control apparatus of claim 1, further comprising:
a counter configured to increase and reduce counts for the respective data buffer regions,
wherein the first buffer controller is configured to increase a count of the number of the data of the first unit stored in each of the data buffer regions by the counter, and
the second buffer controller is configured to reduce a count of the number of the data of the first unit by the counter, when data of the second unit is read from the data buffer region.

3. The storage control apparatus of claim 2, wherein
the counter is configured to increase and reduce counts of the number of data in sector unit which are sequentially transmitted from the host and stored in the respective data buffer regions.

4. The storage control apparatus of claim 3, wherein
the second buffer controller is configured to manage the data of the first unit stored in each of the data buffer regions, as data of the second unit formed of a plurality of data items of the first unit.

5. The storage control apparatus of claim 1, wherein
the second buffer controller is configured to select and set a second bank for next transmission from banks prepared for transmission, and to transmit data of the data buffer region corresponding to the set second bank to the nonvolatile memory, after data of the data buffer region corresponding to a first bank which has been prepared for transmission has been transmitted to the nonvolatile memory, when data is written in the nonvolatile memory.

6. The storage control apparatus of claim 1, wherein
the first buffer controller is configured to execute buffer control of controlling a write pointer and storing data in the data buffer regions, when data is written in the nonvolatile memory, and
the second buffer controller is configured to execute buffer control of controlling a read pointer and reading data from the data buffer regions.

7. A data storage apparatus comprising:
the storage control apparatus of claim 1;
a nonvolatile memory including storage regions for a plurality of banks;
a buffer memory including a plurality of data buffer regions assigned to the banks; and
an interface configured to successively receive data of a first unit sequentially transmitted from a host, and transmit data read from the data buffer regions to the host.

8. The data storage apparatus of claim 7, further comprising:
a nonvolatile storage medium provided separately from the nonvolatile memory; and
a read/write controller configured to write and read data of the first unit stored in the buffer memory in and from the nonvolatile storage medium.

9. The data storage apparatus of claim 7, further comprising:
a counter configured to increase and reduce counts for the respective data buffer regions,
wherein the first buffer controller is configured to increase a count of the number of the data of the first unit stored in each of the data buffer regions by the counter, and
the second buffer controller is configured to reduce a count of the number of the data of the first unit by the counter, when data of the second unit is read from the data buffer region.

10. The data storage apparatus of claim 9, wherein
the counter is configured to increase and reduce counts of the number of data in sector unit which are sequentially transmitted from the host and stored in the respective data buffer regions.

11. The data storage apparatus of claim 10, wherein
the second buffer controller is configured to manage the data of the first unit stored in each of the data buffer regions, as data of the second unit formed of a plurality of data items of the first unit.

12. The data storage apparatus of claim 7, wherein
the second buffer controller is configured to select and set a second bank for next transmission from banks prepared for transmission, and to transmit data of the data buffer region corresponding to the set second bank to the nonvolatile memory, after data of the data buffer region corresponding to a first bank which has been prepared for transmission has been transmitted to the nonvolatile memory, when data is written in the nonvolatile memory.

13. The data storage apparatus of claim 7, wherein
the first buffer controller is configured to execute buffer control of controlling a write pointer and storing data in the data buffer regions, when data is written in the nonvolatile memory, and
the second buffer controller is configured to execute buffer control of controlling a read pointer and reading data from the data buffer regions.

14. A method of storage control applied to a data storage apparatus including a nonvolatile memory including storage regions for a plurality of banks, a buffer memory including a plurality of data buffer regions assigned to the banks, the method comprising:
storing data of a first unit in each of the data buffer regions, the data of the first unit being transmitted from a host and written in the nonvolatile memory, or being read from the nonvolatile memory and transmitted to the host;
transmitting independently data of a second unit from the data buffer region corresponding to a bank prepared for transmission when data is written in the nonvolatile memory; and
transmitting independently data of the second unit from a bank to be read to the data buffer region corresponding to the bank to be read when data is transmitted to the host.

15. The method of claim 14, wherein
the data storage apparatus further includes a counter configured to increase and reduce counts for the respective data buffer regions,
and the method further comprises:
increasing a count of the number of the data of the first unit stored in each of the data buffer regions by the counter, and
reducing a count of the number of the data of the first unit by the counter, when data of the second unit is read from the data buffer region.

16. The method of claim 15, further comprising:
increasing and reducing counts of the number of data in sector unit which are sequentially transmitted from the host and stored in the respective data buffer regions.

17. The method of claim 16, further comprising:
managing the data of the first unit stored in each of the data buffer regions, as data of the second unit formed of a plurality of data items of the first unit.

18. The method of claim 14, further comprising:
selecting and setting a second bank for next transmission from banks prepared for transmission; and
transmitting data of the data buffer region corresponding to the set second bank to the nonvolatile memory, after data of the data buffer region corresponding to a first bank which has been prepared for transmission has been transmitted to the nonvolatile memory, when data is written in the nonvolatile memory.

19. The method of claim 14, further comprising:
executing buffer control of controlling a write pointer and storing data in the data buffer regions, when data is written in the nonvolatile memory; and
executing buffer control of controlling a read pointer and reading data from the data buffer regions.
